(19) United States
(12) Patent Application Publication
(10) Pub. No.: US 2023/0176375 A1
(43) Pub. Date: Jun. 8, 2023

(54) APPARATUS FOR GENERATING A VIRTUAL IMAGE WITH INTERFERENCE LIGHT SUPPRESSION

(71) Applicant: Continental Automotive Technologies GmbH, Hannover (DE)

(72) Inventor: Alexander Wolf, Hainburg (DE)

(73) Assignee: Continental Automotive Technologies GmbH, Hannover (DE)

(21) Appl. No.: 17/921,820

(22) PCT Filed: Apr. 6, 2021
(86) PCT No.: PCT/EP2021/058954

§ 371 Date: Oct. 27, 2022

(30) Foreign Application Priority Data
Apr. 29, 2020 (DE) 10 2020 205 444.4

(51) Int. Cl. G02B 27/01; G02B 27/00

(52) U.S. Cl. CPC G02B 27/0103; G02B 27/0081; G02B 2207/123; G02B 2027/0118

(57) ABSTRACT

A device for generating a virtual image comprising a display element for generating an image, an optical waveguide for widening an exit pupil, and an anti-glare element arranged downstream of the optical waveguide in a beam path wherein the anti-glare element is a shutter is disclosed. A method and a head-up display comprising a device for generating a virtual image are also disclosed.

### CROSS REFERENCE TO RELATED APPLICATIONS

This U.S. patent application claims the benefit of PCT patent application No. PCT/EP2021/058954, filed Apr. 6, 2021, which claims the benefit of German patent application No. 10 2020 205 444.4, filed Apr. 29, 2020, both of which are hereby incorporated by reference.

### TECHNICAL FIELD

The present disclosure relates to a device for generating a virtual image.

### BACKGROUND

A head-up display, also referred to as a HUD, is understood to mean a display system in which the viewer can maintain their viewing direction, since the contents to be represented are superposed into their visual field. While such systems were originally primarily used in the aerospace sector due to their complexity and costs, they are now also being used in large-scale production in the automotive sector.

Head-up displays generally consist of an image generator, an optical unit, and a mirror unit. The image generator produces the image. The optical unit directs the image onto the mirror unit. The image generator is often also referred to as a picture generating unit or PGU. The mirror unit is a partially reflective, light-transmissive pane. The viewer thus sees the contents represented by the image generator as a virtual image and at the same time sees the real world behind the pane. In the automotive sector, the windshield is often used as the mirror unit, and the curved shape of the windshield must be taken into account in the representation. Due to the interaction of the optical unit and the mirror unit, the virtual image is an enlarged representation of the image produced by the image generator.

The viewer can view the virtual image only from the position of what is known as the eyebox. The eyebox, as it is called, is a region whose height and width correspond to a theoretical viewing window. As long as one eye of the viewer is within the eyebox, all elements of the virtual image are visible to that eye. If, on the other hand, the eye is outside the eyebox, the virtual image is only partially visible to the viewer, or not at all. The larger the eyebox is, the less restricted the viewer is in choosing their seating position.

The size of the eyebox of conventional head-up displays is limited by the size of the optical unit. One approach for enlarging the eyebox is to couple the light coming from the picture generating unit into an optical waveguide. The light that is coupled into the optical waveguide undergoes total internal reflection at the interfaces thereof and is thus guided within the optical waveguide. In addition, a portion of the light is coupled out at a multiplicity of positions along the propagation direction. Owing to the optical waveguide, the exit pupil is in this way expanded. The effective exit pupil is composed here of images of the aperture of the image generation system.

Against this background, US 2016/0124223 A1 describes a display apparatus for virtual images. The display apparatus comprises an optical waveguide that causes light that is coming from a picture generating unit and is incident through a first light incidence surface to repeatedly undergo total internal reflection in order to move in a first direction away from the first light incidence surface. The optical waveguide also has the effect that a portion of the light guided in the optical waveguide exits to the outside through regions of a first light exit surface that extends in the first direction. The display apparatus further comprises a first light-incidence-side diffraction grating that diffracts incident light to cause the diffracted light to enter the optical waveguide, and a first light-emergent diffraction grating that diffracts the light that is incident from the optical waveguide.

In the currently known design of such a device, in which the optical waveguide consists of glass plates within which diffraction gratings or holograms are arranged, a problem arises if light is incident from the outside. Stray light may enter the users eye due to reflections of the light that is incident from outside. The contrast of the virtual image perceived by the user is furthermore reduced.

In conventional devices, reflective components are therefore wherever possible tilted and combined with glare traps, so that reflections do not reach the region in which the drivers eye is expected to be. Alternatively, antireflection coatings are employed and structural roughnesses are used in order to reduce the reflection intensity.

The tilting of components significantly takes up installation space, which is limited in automobiles. Furthermore, the performance of the components is generally reduced with tilted installation. Layers and structures lessen the achievable intensity, but the reflections generally remain clearly visible and significantly reduce the contrast.

WO 2019/238849 A1 discloses a device with an anti-glare element in the form of a switchable closure. This requires a quickly switchable closure, which requires a great deal of labor and/or money if the quality is to remain good.

It is an object of the present disclosure to provide an improved device for generating a virtual image, with which the influence of stray light is reduced.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

According to a first aspect of the disclosure, a device for generating a virtual image has a display element for generating an image, an optical waveguide for expanding an exit pupil of the generated image, and an anti-glare element arranged downstream of the optical waveguide in the beam path, wherein the anti-glare element is a shutter. The slats of the shutter are able to block the reflection of a large-area reflecting mirror, which is what the optical waveguide acts as. The influence of stray light is thus effectively reduced. The slats are aligned in such a way here that light coming from the display element passes through them almost unaffected, but stray light incident from outside is blocked, in particular absorbed, by the slats. In this case, the shutter may additionally be provided with a transparent cover having a curved surface, which concentrates light incident from outside in a light trap instead of reflecting it in the direction of the user's eye. For example, however, no such cover is provided, which means that the shutter does not have to have a curved shape, which simplifies its manufacture.

According to one configuration of the disclosure, the shutter has slats whose height is at least n times their thickness, where n is a first factor with n>10. The slats are thin and have only little or no influence on the light coming from the optical waveguide. A human viewer of the virtual image therefore does not perceive the presence of the shutter. The slats of the shutter are also so thin that they may be arranged so close together that dirt particles may hardly penetrate into the intermediate space between two slats, since most dirt particles are too large for this. Contamination of the intermediate space between the slats is thus avoided. The value of the first factor is for example n=80. This makes it almost impossible for dirt particles to penetrate deeper into the shutter and also prevents dirt particles from penetrating through the shutter into the device and contaminating the optical elements inside the device. Even fine water droplets that might be present outside the device are thus prevented from penetrating into the device. Should the shutter nevertheless become dirty during operation over a long period of time, the shutter is configured as an easily interchangeable element that is able to be replaced with a new one, for example as part of routine maintenance of the device, without great expenditure in terms of time and money.

The slats are hardly reflective in the visible wavelength range, for example non-reflective. For example, they absorb incident visible light. The slats for example dissipate the energy that is absorbed in the process. For example, they are good thermal conductors or diffusely radiate thermal energy.

In the temperature range from −40° C. to 120° C., the slats preferably exhibit a constant or only slight temperature-related change in extension. A change in extension with regard to the width and the height is less critical than with regard to its smallest extension, the thickness.

According to one configuration of the disclosure, the shutter is arranged in a frame in which the slats are fixed at a fixed distance from one another. By means of this measure, the glare protection acts uniformly over the entire area of the anti-glare element. The virtual image is thus visible undisturbed by glare in the entire intended visibility region, the so-called eyebox. The distance depends on boundary conditions such as the orientation of the device relative to other optical elements with which it is intended to interact and their properties. If these are known, the value of the distance is also determined and constant for all slats.

The solution according to the disclosure makes it possible to suppress visible reflections caused by external stray light. In addition, there is increased flexibility with regard to the spatial arrangement of the optical components, since no special tilting of the components is required to reduce stray reflections, but a suitable alignment of the slats is sufficient herefor. The space required for installation may thus be reduced compared with other designs. The thermal load on the components is also reduced, for example because of the omission of light traps or the smaller amount of light that is incident from outside and would otherwise be absorbed inside the device.

According to the disclosure, the device has an optical waveguide for expanding an exit pupil. A particularly large eye box can be achieved by using an optical waveguide for expanding an exit pupil. However, with a device designed in this way, incident light has quite a disruptive effect, so that suppression of stray light by means of the solution according to the disclosure is advantageous.

According to the disclosure, the shutter has slats which consist, for example, of a plastic such as polyethylene or polyester. However, plastics strips that have the desired properties are not easy to handle. Therefore, a slat of the shutter consists, according to the disclosure, of a fabric of individual carbon fibers. A carbon fiber usually has a diameter of 5-9 micrometers; 1000 to 24 000 carbon fibers are therefore usually connected to form a fiber bundle, also known as a yarn. Such a fiber bundle is less suitable for the purposes of the disclosure because of its round cross section and its large diameter. Therefore, a fabric that does not require weft threads aligned transversely to the direction of the individual fibers but has an elongate cross section is proposed. Such a fabric or knitted fabric may be produced, for example, by a process corresponding to or similar to knotting. It has the desired thickness-to-height ratio and can be manufactured in the desired width. In the desired temperature range, it shows little or no thermal change in length, absorbs visible light, and is a good conductor of heat. Increasing or reducing the height of a slat while maintaining the width may be achieved during manufacture simply by increasing or decreasing the number of layers of carbon fibers.

According to one embodiment, the fabric is fixed at both ends. Fixing prevents the shape of the fabric from changing and thus permanently ensures the desired geometric dimension of the slat. Fixing takes place, for example, by welding the carbon fibers, by hot melt coating, by overmolding, or by other suitable methods.

In one embodiment, fixing takes place by stabilizers arranged at both ends of the fabric, which are held in position by guide elements. The length of the slats and a minimum pretension of the slats are ensured in this way. The slats thus retain their defined shape, which ensures glare protection even under changing ambient conditions, for example changing temperature, changing humidity or the like.

In one embodiment, the slats are aligned by means of an alignment element. This ensures a specified distance between the slats and the angular orientation of the slats at an optimum angle. The alignment element has, for example, guide surfaces for individual slats, wherein the guide surfaces have an individual inclination provided for the respective slats.

According to the disclosure, the optical waveguide has an output coupling hologram which couples out light at an angle deviating from the normal on the exit surface of the optical waveguide. The slats of the shutter are accordingly arranged at an angle that allows the coupled-out light to pass through. Stray light coming in this direction from the outside through the slats, in particular sunlight, is then reflected by the exit surface of the optical waveguide at an angle which deviates from that of the slats and is thus blocked or absorbed by them. Glare is thus suppressed even in the event that stray light coming from outside may pass through the slats.

The solution according to the disclosure may be applied not only to head-up displays that have exit-pupil-enlarging optical waveguides with a large, planar light-emitting surface, but also to conventional head-up displays or other display or projection systems that have a correspondingly large surface that is susceptible to stray light being incident thereon.

Further features of the present disclosure will become apparent from the following description and the appended claims in conjunction with the figures.

### BRIEF DESCRIPTION OF THE DRAWINGS

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 schematically shows a device according to the disclosure for generating a virtual image;

FIG. 6 shows an alternative optical waveguide with two-dimensional enlargement;

FIG. 7 schematically shows a device according to the invention for generating a virtual image;

FIG. 8 shows a shutter and a detail enlargement thereof;

FIG. 9 shows a shutter and the construction of the slats of the shutter;

FIG. 10 schematically shows part of the manufacturing process for a shutter according to the disclosure;

FIG. 11 schematically shows a further part of the manufacturing process for a shutter according to the disclosure;

FIG. 12 schematically shows a further part of the manufacturing process for a shutter according to the disclosure; and

FIG. 13 shows a flowchart of a method according to the disclosure.

### DETAILED DESCRIPTION

For a better understanding of the principles of the present disclosure, embodiments of the disclosure will be explained in more detail below with reference to the figures. The same reference signs are used in the figures for identical or functionally identical elements and are not necessarily described again for each figure. It is to be understood that the disclosure is not limited to the illustrated embodiments and that the features described may also be combined or modified without departing from the scope of protection of the disclosure as it is defined in the appended claims.

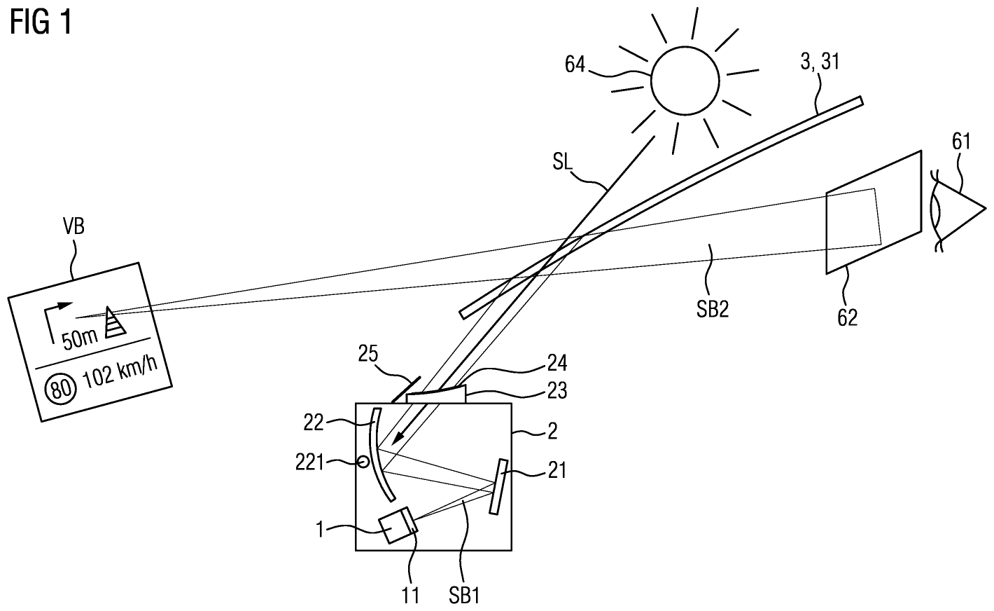

First, the basic concept of a head-up display with an optical waveguide will be explained with reference to FIGS. 1 to 4.

FIG. 1 shows a schematic diagram of a head-up display according to the prior art for a motor vehicle. The head-up display has an image generator 1, an optical unit 2, and a mirror unit 3. A beam of rays SB1 emanates from a display element 11 and is reflected by a folding mirror 21 onto a curved mirror 22, which reflects it in the direction of the mirror unit 3. The mirror unit 3 is represented here as a windshield 31 of a motor vehicle. From there, the beam of rays SB2 travels in the direction of an eye 61 of a viewer.

The viewer sees a virtual image VB that is located outside the motor vehicle above the engine hood or even in front of the motor vehicle. Due to the interaction of the optical unit 2 and the mirror unit 3, the virtual image VB is an enlarged representation of the image displayed by the display element 11. A speed limit, the current vehicle speed, and navigation instructions are symbolically represented here. As long as the eye 61 is within the eyebox 62, which is indicated by a rectangle, all elements of the virtual image are visible to the eye 61. If the eye 61 is outside the eyebox 62, the virtual image VB is only partially or not at all visible to the viewer. The larger the eyebox 62 is, the less restricted the viewer is when choosing their seating position.

The curvature of the curved mirror 22 serves to condition the beam path and thus to ensure a larger image and a larger eyebox 62. In addition, the curvature compensates for a curvature of the windshield 31, with the result that the virtual image VB corresponds to an enlarged reproduction of the image represented by the display element 11. The curved mirror 22 is rotatably mounted by a bearing 221. The rotation of the curved mirror 22 that is made possible thereby makes it possible to displace the eyebox 62 and thus to adapt the position of the eyebox 62 to the position of the eye 61. The folding mirror 21 serves to ensure that the path traveled by the beam of rays SB1 between the display element 11 and the curved mirror 22 is long but, at the same time, that the optical unit 2 is nevertheless compact. The optical unit 2 is separated from the environment by a transparent cover 23. The optical elements of the optical unit 2 are thus protected for example against dust located in the interior of the vehicle. An optical film 24 or a coating that is intended to prevent incoming sunlight SL from reaching the display element 11 via the mirrors 21, 22 is furthermore situated on the cover 23. Said display element 11 could otherwise be temporarily or permanently damaged by the resulting development of heat. In order to prevent this, an infrared component of the sunlight SL is for example filtered out by means of the optical film 24. Glare protection 25 serves to shade light incident from the front so that it is not reflected by the cover 23 in the direction of the windshield 31, which could cause the viewer to be dazzled. In addition to the sunlight SL, the light from another stray light source 64 can also reach the display element 11.

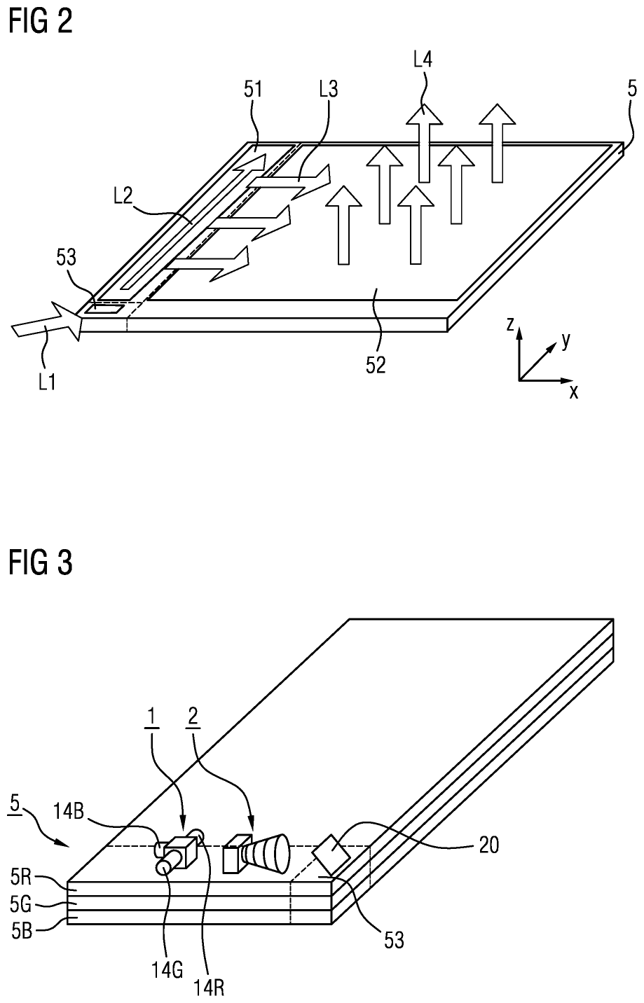

FIG. 2 shows a schematic spatial illustration of an optical waveguide 5 with two-dimensional enlargement. In the lower left region, an input coupling hologram 53 can be seen, by which light L1 coming from a picture-generating unit (not illustrated) is coupled into the optical waveguide 5. It propagates therein to the top right in the drawing, according to the arrow L2. In this region of the optical waveguide 5, there is a folding hologram 51 that acts similarly to many partially transmissive mirrors arranged one behind the other and produces a light beam that is expanded in the Y-direction and propagates in the X-direction. This is indicated by three arrows L3. In the part of the optical waveguide 5 that extends to the right in the figure, there is an output coupling hologram 52, which likewise acts similarly to many partially transmissive mirrors arranged one behind the other and couples light, indicated by arrows L4, upward in the Z-direction out of the optical waveguide 5. In this case, broadening takes place in the X-direction, so that the original incident light beam L1 leaves the optical waveguide 5 as a light beam L4 that is enlarged in two dimensions.

FIG. 6 shows a schematic illustration of an optical waveguide with two-dimensional enlargement, which is an alternative to FIG. 2. Here, the output coupling hologram 52 is configured in such a way that it couples light out not perpendicularly to the surface of the optical waveguide 5 but at an angle to the Z-direction, as illustrated by the arrows L4. In this way, the optical waveguide 5 may be arranged according to the available installation space, without having to allow for perpendicular emergence of the light beam enlarged in two dimensions.

FIG. 3 shows a spatial illustration of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are wavelength-dependent, so that one optical waveguide 5R, 5G, 5B is respectively used for one of the elementary colors. An image generator 1 and an optical unit 2 are illustrated above the optical waveguide 5. The optical unit 2 has a mirror 20, by which the light produced by the image generator 1 and shaped by the optical unit 2 is deflected in the direction of the respective input coupling hologram 53. The image generator 1 has three light sources 14R, 14G, 14B for the three elementary colors. It may be seen that the entire unit shown has a small overall height compared with its light-emitting surface.

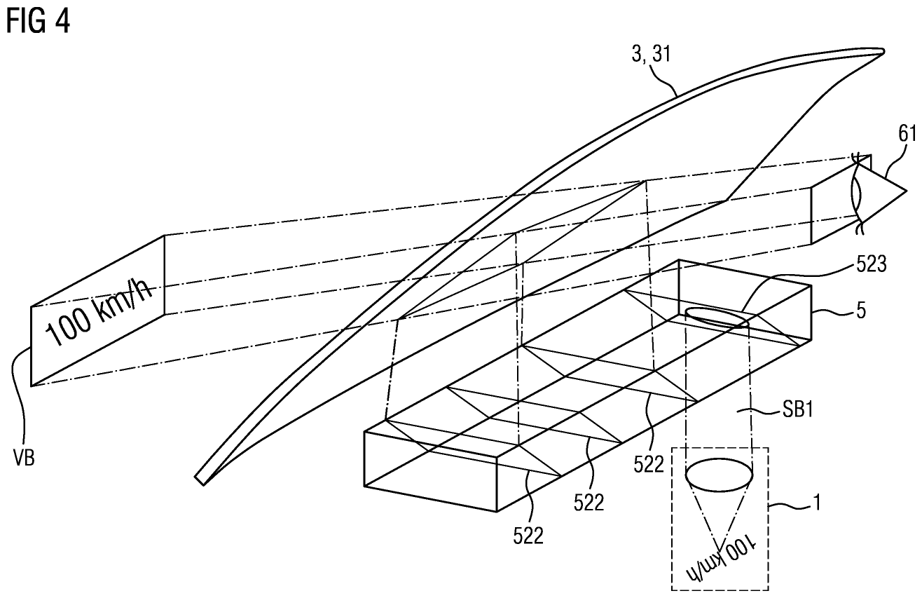

FIG. 4 shows a head-up display in a motor vehicle similar to FIG. 1, but here in a spatial illustration and with an optical waveguide 5. It shows the schematically indicated image generator 1, which produces a parallel beam of rays SB1 that is coupled into the optical waveguide 5 by means of the mirror plane 523. The optical unit is not illustrated for the sake of simplicity. A plurality of mirror planes 522 each reflect some of the light incident thereon into the direction of the windshield 31, the mirror unit 3. From here, the light is reflected in the direction of the eye 61. The viewer sees a virtual image VB above the engine hood or at an even farther distance in front of the motor vehicle.

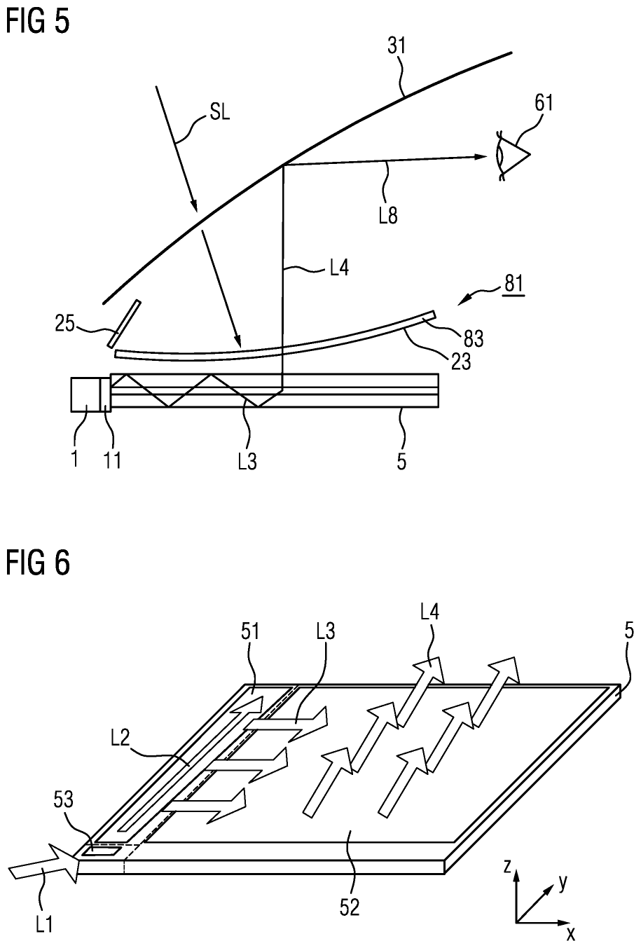

FIG. 5 shows a device according to the disclosure in a schematic illustration. It shows the image generator 1 with the display element 11, the optical waveguide 5, the cover 23 serving as anti-glare element 81 with integrated shutter 83, the glare protection 25 serving as light trap, the windshield 31, and the eye 61 of the user. In this example, the anti-glare element is integrated into a conventional cover used for glare protection.

FIG. 5 also shows how the incidence of sunlight on the optical waveguide 5 is reduced by the anti-glare element 81. The shutter 83 arranged in the anti-glare element 81 is transmissive in the direction of the light L4 emerging from the optical fiber 5 in the direction of the windshield 31. Sunlight SL incident from outside can only pass through the anti-glare element 81 if it is incident in precisely this direction. Otherwise, the sunlight SL is absorbed by the slats 82 (not illustrated here) of the shutter 83. If an optical waveguide 5 is used in which the exiting light L4 does not exit perpendicularly but, as shown in FIG. 6, at an angle to it, incident sunlight SL is reflected at the surface of the optical waveguide 5 in a direction that is not parallel to the slats of the shutter, and is blocked by the latter. Glare is thus prevented even in this situation.

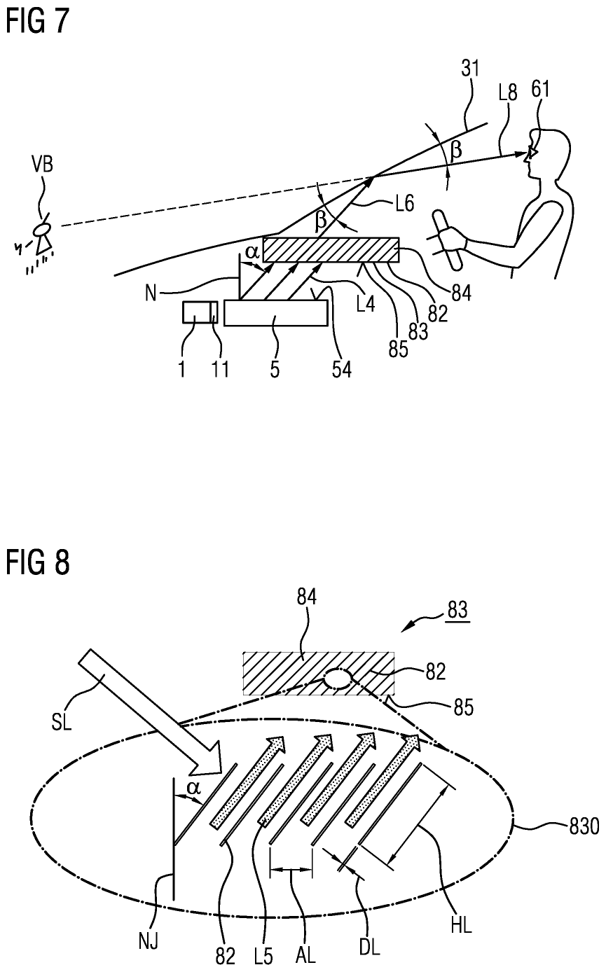

FIG. 7 shows a device according to the disclosure similar to FIG. 5, in which an optical waveguide 5 is used in a manner corresponding to FIG. 6. It shows the image generator 1 with the display element 11 and the optical waveguide 5, from which the light L4 exits at an angle α to the normal N on the light exit surface 54 of the optical waveguide 5, wherein the angle α is greater than 0°. The emerging light L4 is incident on the light entry surface 85 of the shutter 83, the slats 82 of which are arranged parallel to the emerging light L4, so that it can pass unimpeded through the intermediate spaces 84 between the slats 82. The light L6 emerging from the shutter 83 is incident on the windshield 31 at an angle β and is reflected thereby and reaches the eye 61 of a vehicle occupant, here the driver, as light L8. The latter therefore sees a virtual image VB. In this embodiment, the shutter 83 forms the cover of the optical unit, and a separate cover element is not provided. The shutter 83 may therefore also come in direct contact with objects or persons located in the interior of the vehicle. Damage to the shutter 83 is therefore not precluded. The shutter 83 is therefore arranged releasably so that, if need be, it is removed without great effort and replaceable with a new or repaired shutter 83. The slats 82 are very thin; in the embodiment, they have a thickness DL of DL=25 μm.

FIG. 8 shows the shutter 83 and a detail enlargement 830. It shows the slats 82, which let through the light L5 that emanates from the optical waveguide 5 and travels substantially parallel to the slats 82. Stray light SL that does not travel parallel to the slats 82 is blocked by the slats 82. The slats 82 have a spacing AL from one another and are inclined by an angle α with respect to the normal NJ to the light entry surface 85 of the shutter 83. The slats have a height HL and a thickness DL, wherein the height HL is a multiple of the thickness DL. In the embodiment, the thickness DL=25 μm, while the height HL is approximately 2 mm. The angle α corresponds to that of the light emergence from the optical waveguide 5 when the light exit surface 54 of the latter and the light entry surface 85 of the shutter 83 are arranged parallel to one another. In the case of a non-parallel arrangement, these angles are to be converted accordingly. The angle α depends, inter alia, on the position of the driver and their angle of view. For different types of vehicle or different inclinations of the windshield 31, inter alia the distance AL needs to be adapted. The slats 82 are for example configured to be non-reflective, that is to say substantially black. At a height HL of approximately 2 mm, one purpose of the slat is achieved, to be specific that of absorbing all other rays that are incident on the system from above. This requires a certain overlap, which is achieved with this height.

The figure shows the light rays L5 parallel to one another. This is certainly at least approximately true on a small scale. In many cases, however, there is an angular deviation over larger distances, and the alignment of the slats then has to be adapted thereto. For example, if the pane that serves as the image-generating plane is curved, the light rays are incident on a curved surface. If the slats were all aligned at the same angle, this would shade some of the light rays. This means that the angle at which the individual slats are aligned must match the curvature and thus the respective reflection angle in the region of the pane, otherwise the image information cannot be seen at all points. FIG. 8 shows light rays arriving in a plane-parallel manner. In many applications, however, these exhibit a very small change in the angle with respect to one another. Depending on the variation of the angles over the surface of the shutter, provision is made for the height of the slats to be adapted accordingly. Slats that are arranged relatively steeply then have a lower height than those that are arranged so as to be relatively flatter.

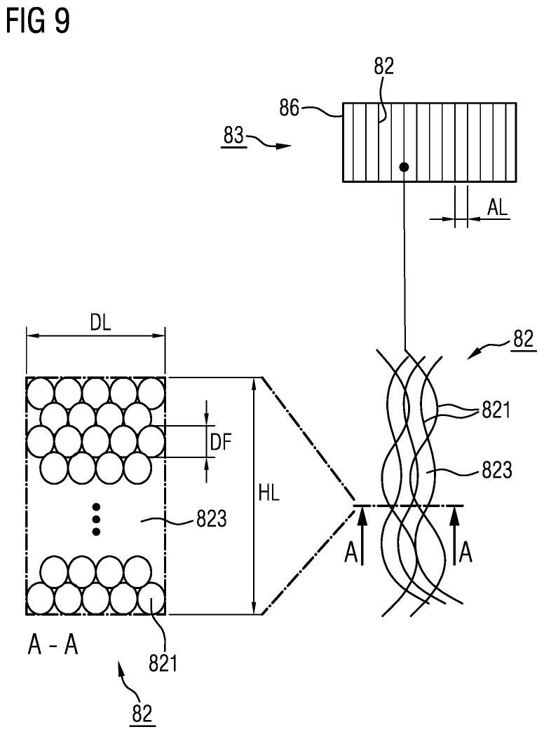

FIG. 9 shows a shutter and the construction of the slats of the shutter. The figure shows in its upper right region a shutter 83 which is fixed in a frame 86. The upper edge of the slats 82 can be seen. The slats 82 are arranged at a constant distance AL from one another. In the exemplary embodiment, the distance AL is approximately 1 mm. The slats 82 run obliquely downwards, which cannot be seen in this plan view, since the slats 82 are shown here in side view in white for the sake of clarity, although they are actually black or almost black. Both the oblique profile and the distance AL are selected differently for different boundary conditions. When the device according to the disclosure is used in a head-up display for a vehicle, these boundary conditions differ from vehicle type to vehicle type and possibly also for different variants of a vehicle type.

In the lower right region of FIG. 9, a greatly enlarged schematic plan view of the upper edge of a slat 82 is shown. A plurality of carbon fibers 821 that are woven together can be seen. Such a bundle of carbon fibers 821 is also referred to as bride. The individual carbon fibers 821 have the shape of a helix, for example, wherein adjacent helices intermesh and thus form a stable fabric 823. A schematic enlarged sectional view along the line AA is shown in the left part of FIG. 9.

The enlarged sectional view AA in the left part of FIG. 9 shows a schematic section through a slat 82. Many carbon fibers 821 may be seen, which are shown here in an idealized densely packed manner and form the fabric 823. The carbon fibers 821 have a diameter DF which is approximately in the range DF=5 μm to DF=9 μm. The fabric 823 has a thickness of approximately three to five layers of carbon fibers 821, and so the thickness DL of the slat 82 is approximately DL=25 μm. The height HL of the slat 82 and thus of the fabric 823 is approximately HL=2 mm. The height HL is therefore linked to the thickness DL by a factor F1:HL=F1*DL. The height HL of the slat 82 is a multiple of its thickness DL. This is indicated by three points. The fabric 823 is made in a process similar to knotting or braiding or knitting using individual carbon fibers 821. These are considerably thinner fibers than are usually used in knotting, braiding or knitting. The production of the fabric 823 is therefore also referred to below as micro weaving. If slats of greater or lesser height HL are required, this is achieved by increasing or decreasing the number of micro-woven carbon fibers 821 in the direction of the height HL. Also, the thickness DL can be adjusted by increasing or decreasing the number of micro-woven carbon fibers 821 in the direction of the thickness DL. In addition or as an alternative to this, provision is made to adapt the diameter DF of the carbon fibers 821 in order to adapt the thickness DL or the height HL. Carbon fibers 821 corresponding to a constant diameter are industrially produced and are thus available.

In the temperature range from −40° C. to 120° C., the slats preferably exhibit a constant or only slight temperature-related change in extension. A change in extension with regard to the width and the height is less critical than with regard to the thickness.

A change in the width of the slats, that is to say their longest extension, is less critical here. A width extension is almost unavoidable due to the length of the slat and the size of the holding frame. The fabric made of carbon fibers according to the disclosure, also referred to as “carbon shoelaces”, may be tightened to a certain extension while changing its thickness only slightly. One of the reasons for this is that there are only about five layers of carbon fibers here. Changing the height of the slats is also less critical since the shading is mainly affected by the angle. The thickness of the slats is critical. If the slat becomes too thick, it is visually perceptible and then breaks up the image into strips.

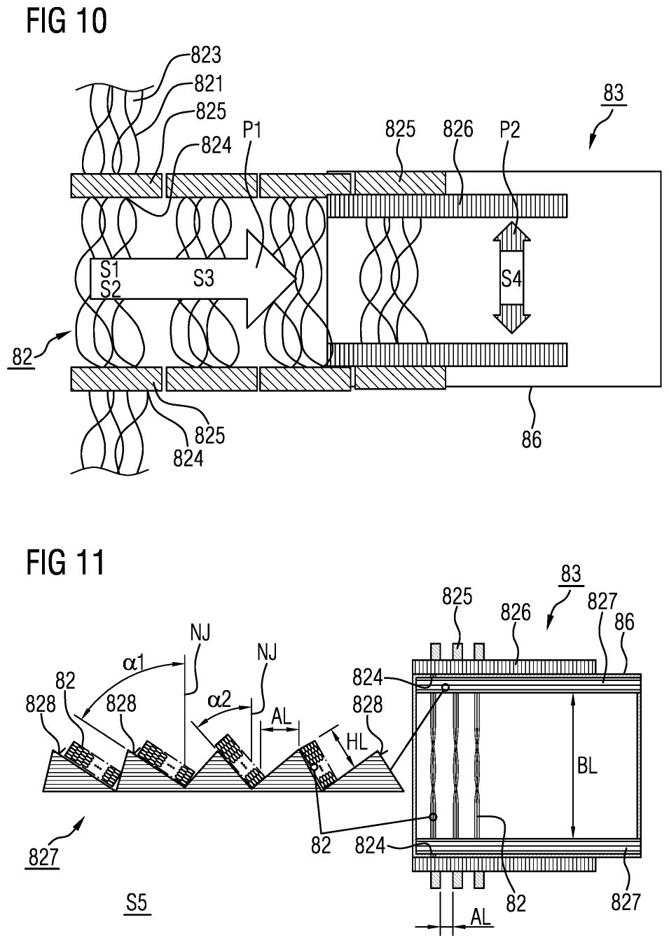

FIG. 10 schematically shows part of the manufacturing process for a shutter 83 according to the disclosure; This is done in a plan view corresponding to the right-hand part of FIG. 9 and in an illustration that is not true to scale. A fabric 823 of carbon fibers 821 which has not yet been cut to the width BL of a slat 82 after micro weaving S1 can be seen on the left. The fabric 823 is then tensioned S2. Stabilizers 825 are attached at the future ends 824 of the slat 82. These ensure that the fabric 823 retains its shape and structure even after it has been cut to length S3. The stabilizers 825 are produced, for example, by fusing the carbon fibers 821 in this region by introducing stabilizing material into this region, by using a different type of linkage, braiding or weaving in this region, or by any other suitable measure.

The fabric 821 is then cut to length S3 in the direction of the arrow P1. According to one embodiment, the stabilizers 825 are already sufficient to maintain the length of the fabric 823 in the direction of the width BL of the slat 82 and its tension in this direction. According to another embodiment, guide elements 826 are provided which interact with the stabilizers 825 and ensure S4 the spacing between the stabilizers 825 at the two ends 824 of the slat 82 and the tension of the fabric 823 arranged between the two ends 824. This is indicated by the double-headed arrow P2. The guide elements 826 interact with the frame 86 of the shutter 83. According to one embodiment, the guide elements 826 are integrated into the frame 86. According to another embodiment, they are attached to the frame 86.

FIG. 11 schematically shows a further part of the manufacturing process for a shutter 83 according to the disclosure. The right-hand part of the figure shows the frame 86, in the outer region of which the guide elements 826 and then on the outside the stabilizers 825 are arranged. An alignment element 827 is located within the frame 86 in the region of the ends 824. The alignment elements 827 serve to adjust the inclination of the slat 82. The left-hand part of the figure shows a lateral view of an alignment element 827. It has guide surfaces 828 which have different angles of inclination α1, α2 to the normal NJ. The slat 82 is aligned S5 by placing the individual slats 82 on individual, assigned guide surfaces 828 of the alignment elements 827. The guide surfaces 828 are arranged such that the desired distance AL between the slats 82 is maintained.

The height HL of a slat 82 may be seen in the left-hand part of FIG. 11 and its width BL in the right-hand part. The width BL is linked to the height HL by a factor F2:BL=F2*HL. The value of the factor F2 lies in a range of 10-100, and so the width BL of a slat 82 is a multiple of its height HL. The thickness DL, height HL and width BL of the slats 82 thus differ from one another by at least one order of magnitude. This places high demands on the material of the slat 82. According to the disclosure, carbon fibers 821 are provided, which meet these requirements.

Carbon fibers 821 withstand high stresses. The flexibility of the fabric 823 required to compensate for thermally induced extension of the frame 86 may be set by selecting a suitable micro-weaving process and/or the pretension set at the end of the manufacturing process. After the distance and tension have been ensured S4 and after the slat 82 has been aligned S5, the aligned slat 82 is fixed S6.

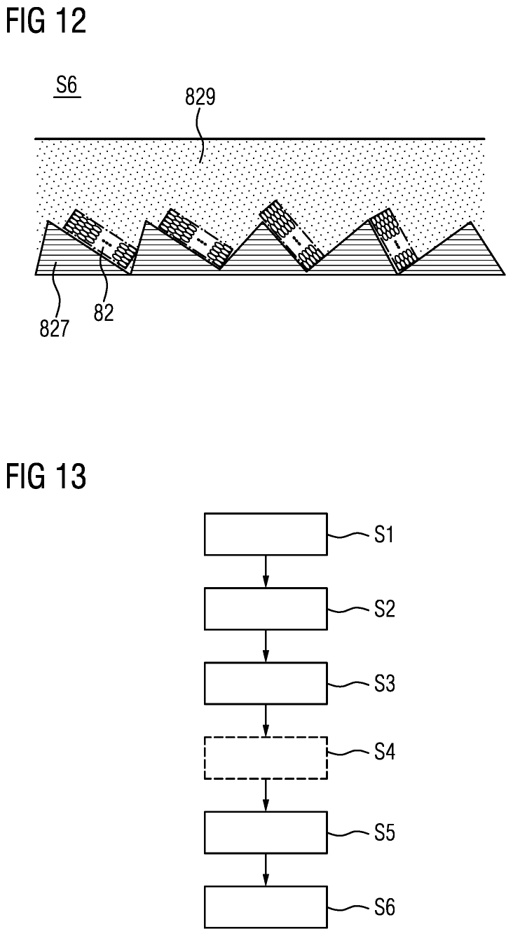

This is shown by way of example in FIG. 12. In this embodiment, a fixing compound 829 is applied to the alignment element 827 and the slat 82 aligned thereon. This is, for example, a hot melt compound, a curing adhesive compound or another suitable material.

FIG. 13 shows a flow chart of a method according to the disclosure. This method comprises micro weaving S1 individual carbon fibers 821 to form a fabric 823 whose height HL is greater than its thickness DL at least by a first factor F1, tensioning S2 the fabric 823 over a width BL which is greater than its height HL by at least a second factor F2, cutting S3 the tensioned fabric 823 into a slat 82, aligning S5 individual slats 82 relative to one another, and fixing S6 the aligned slats 82. Optionally, the distance and tension are also ensured S4.

The slats for example have different angles for different positions of the eye 61 within the eyebox 62. Such different positions occur, for example, when the driver changes their seated position in terms of height or lateral orientation, or when drivers of different heights drive the vehicle. The angle at which the individual slats are aligned is therefore preferably variable during operation. The angle of the slats is ideally adjusted using “head tracking” of the driver so that no unwanted shading occurs. The slats are individually mounted. This enables handling during assembly. An adjustment can be implemented, for example, by moving the stabilizer 825 from FIG. 10 forwards and backwards. As a result, all slats are adjusted at the same angle. If an individual adjustment is required, the slats are driven individually or combined in groups using a worm shaft, for example. This individually influences the angle. Separate, individually controlled slats are possible, for example, with the aid of a memory wire, which contracts when a voltage is applied, causing the slat to rotate.

In other words, the disclosure relates to the following. Conventional head-up display systems in vehicles work with mirrors and have a curved pane as a cover in the vehicle that prevents reflection. When switched off, the mirrors are parked in a position that prevents damage from sunlight. A new generation of optical display instruments operates with an optical waveguide 5 in which holograms 51, 52 in a pane of glass direct light L1 from the projection source, the image generator 1, at the right angle to the driver. Since the surface of the optical waveguide 5 is planar, reflections of sunlight SL in the direction of the driver can occur, which should be prevented.

A curvature of the surface of the optical waveguide 5 is not possible or possible only with disproportionate effort due to the optical tasks said optical waveguide has to fulfill. An anti-reflective coating using conventional means is not sufficient due to the size of the optical waveguide 5, since even with such an anti-reflective coating too much light may still be guided in the direction of the driver. Shading of the solar radiation in the direction of the driver is therefore desirable.

According to the disclosure, a shutter 83 is mounted on the optical waveguide 5 in a frame 86 that accommodates microwoven carbon fibers, the carbon fibers 821. These microwoven carbon fibers form the slats 82 of the shutter 83. When they are manufactured, the fibers 821 are first micro-woven S1 with attachment/fixing of the fibers 821 at both ends 824 with the aid of appropriate stabilization, the stabilizers 825. The stabilizers 825 prevent the structure of the resulting fabric 823, which is, for example, a helix structure or a bride structure (carbon fiber bride shape), from losing its shape again. The stabilizer 825 may be firmly connected to the carbon fibers 821 with the aid of an injection molding process, for example. As an alternative, a method using hot-melt bonding or encapsulation with a thermoset is also possible. In addition, it is necessary to keep the structures that arise in this way under tension in order to prevent the fabric 823 from unraveling or undergoing a mechanical deformation. For this purpose, the fabric, which is in the form of helix structures, for example, is pushed onto a frame 86 with guide elements 827. This achieves a constant distance and constant tensile stress for the components. With an appropriate design, this frame 86 may already be the final frame 86 of the shutter 83, so that further components may be omitted. The individual microwoven slats 82 of the shutter 83 are aligned using alignment elements 827 of appropriate geometry with the necessary angles α1, α2 and the corresponding distance AL on the frame 86 of the shutter 83. The necessary tensile stress for the final installation is applied to the individual slats 82 via the combination of stabilizers 825 and guide elements 826. Under tension, the individual slats 82 are fixed at the intended angles α1, α2 and distances AL and then fastened, for example by hot-melt bonding/thermoset encapsulation/injection molding.

Carbon fiber structures are currently used in a variety of ways, but these are macroscopic applications. Carbon fibers 821 are insensitive to temperature fluctuations and have a very high tensile strength. At the same time, a fabric 823 with, for example, a “braid” helix structure offers flexibility. Since the slats 82 and thus the fabric 823 can be reached by the driver, the properties of the carbon fibers 821 and the fabric 823 made therefrom reduce the risk of damage to the shutter 83. Material costs for the carbon fibers 821 are minimal. With many individual fabrics 823, for example in the form of helix fibers, cables or support structures may also be implemented in principle.

1. A device for generating a virtual image, comprising:
a display element for generating an image;
an optical waveguide for expanding an exit pupil; and
an anti-glare element arranged downstream of the optical waveguide in a beam path, wherein the anti-glare element is a shutter.

2. The device as claimed in claim 1, wherein the shutter comprises slats whose height is at least n times their thickness, where n is a first factor with n>10.

3. The device as claimed in claim 1, wherein the shutter is arranged in a frame in which slats are fixed at a fixed distance from one another.

4. The device as claimed in claim 1, wherein a slat of the shutter consists of a fabric of individual carbon fibers.

5. The device as claimed in claim 4, wherein the fabric is fixed at both ends.

6. The device as claimed in claim 4, wherein the fabric is fixed by stabilizers arranged at both ends of the fabric and held in position by guide elements.

7. The device as claimed in claim 2, wherein the slats are aligned by an alignment element.

8. The device as claimed in claim 1, wherein the optical waveguide has an output coupling hologram which couples out light at an angle deviating from the normal on the exit surface of the optical waveguide.

9. A method for manufacturing a shutter for a device, the method comprising:
micro weaving individual carbon fibers to form a fabric whose height is greater than its thickness at least by a first factor;
tensioning the fabric over a width which is greater than its height by at least a second factor;
cutting the tensioned fabric into a slat;
aligning individual slats relative to one another; and
fixing the aligned slats.

10. A head-up display, comprising:
a device for generating a virtual image, comprising:
a display element for generating an image;
an optical waveguide for expanding an exit pupil; and
an anti-glare element arranged downstream of the optical waveguide in a beam path, wherein the anti-glare element isa shutter; and a mirror unit, wherein the light emanating from the optical waveguide is incident on the mirror unit at a specified angle and the shutter is aligned in accordance with the direction of the light emanating from the optical waveguide.

11. A head-up display as claimed in claim 10, wherein the head-up display generates the virtual image for a driver of the vehicle.
